(19) United States
(12) Patent Application Publication
(10) Pub. No.: US 2019/0219455 A1
(43) Pub. Date: Jul. 18, 2019

(54) TIRE TEMPERATURE INDICATOR

(71) Applicants: Bridgestone Americas Tire Operations, LLC, Nashville, TN (US); Firestone Building Products Company, LLC, Nashville, TN (US)

(72) Inventors: Wensheng Zhou, Carmel, IN (US); Francis J. Byrne, Franklin, TN (US); David O. Stalnaker, Brentwood, TN (US); Robert Palmer, Murfreesboro, TN (US)

(21) Appl. No.: 16/329,342

(22) PCT Filed: Aug. 29, 2017
(86) PCT No.: PCT/US17/49063

§ 371 Date: Feb. 28, 2019

Related U.S. Application Data
(60) Provisional application No. 62/382,334, filed on Sep. 1, 2016.

(51) Int. Cl. G01K 11/12; B60C 13/00; B60C 23/04; B60C 23/20

(52) U.S. Cl. CPC G01K 11/12; B60C 23/20; B60C 23/0408; B60C 13/001

(57) ABSTRACT

A tire having an indicator device that visually indicates exposure of the tire to a pre-selected temperature is provided, and an indicator device that may be positioned on a tire, for indicating that the tire has been exposed to a pre-selected temperature. The device includes expandable graphite dispersed within a pouch or binder. Also described is a method for detecting that a tire has been exposed to excessive temperature. The method includes providing a tire that includes at least one indicator device that contains a pouch or binder and expandable graphite dispersed in the pouch or binder. Visual inspection of the tire to detect a change in the appearance, shape, volume or texture of the indicator device can indicate that the tire has been exposed to a temperature that meets or exceeds a pre-selected temperature.

### FIELD OF THE INVENTION

Embodiments of the present invention are directed toward tires having an indicator device that indicates exposure of the tire to a pre-selected temperature. The indicator device includes expandable graphite and a pouch or binder.

### BACKGROUND OF THE INVENTION

Excessive heat can be generated in a tire, for example, when the tire is improperly inflated, and/or if the tire is improperly loaded. Excessive heat can harm rubber components and adhesion between components within the tire. Currently, the damage that may have been done to a tire by exposure to elevated temperatures is not readily apparent, and cannot be determined without removing the tire and performing testing. There is a need in the art for an indicator device on the tire that provides a visual indication that the tire has been exposed to excessive temperatures.

### BRIEF DESCRIPTION OF THE DRAWINGS

Embodiments of the invention are set forth in the following description and are shown in the drawings and are particularly and distinctly pointed out and set forth in the claims.

FIG. 1 is a sectional view of a tire.

### DETAILED DESCRIPTION OF ILLUSTRATIVE EMBODIMENTS

Embodiments of the invention are based, at least in part, on the discovery of a tire having an indicator device that indicates exposure of the tire to an excessive temperature. The indicator device may be positioned on a tire, for indicating that the tire has been exposed to a pre-selected temperature. Accordingly, embodiments of the present invention provide an indicator device that comprises expandable graphite and a pouch or binder.

Indicator

In one or more embodiments, the indicator may be in the form of a coating, a resin strip, or a pouch. In one or more embodiments, the indicator may be located on a surface of a tire. As will be described in greater detail herein, the indicator may be multi-layered, wherein at least one layer includes expandable graphite and a pouch or binder.

The indicator may initially be characterized by a certain, uniform appearance, shape, volume, and a relatively smooth surface. Under conditions of standard temperature and pressure, and under the normal operating conditions of a tire, the appearance, shape, volume, and texture of the indicator does not substantially change.

However, in one or more embodiments, after exposure of the indicator to an elevated temperature, the appearance, shape, volume, and/or texture of the indicator surface is visually different, primarily due to the change in the appearance, shape, volume, and/or texture of the expandable graphite.

Expandable Graphite

Expandable graphite may also be referred to as expandable flake graphite, intumescent flake graphite, or expandable flake; and, for the purposes herein, these terms may be used interchangeably. Expandable graphite is so-named because, when heated to or above a certain temperature, often referred to as the onset temperature, the expandable graphite particles are expanded perpendicularly to the layer plane.

In one or more embodiments, the expandable graphite includes intercalated graphite, in which an intercallant material is included between the graphite layers of graphite crystals or particles. In these or other embodiments, when the expandable graphite is exposed to elevated temperatures that are at or above the onset temperature, the intercallant compound changes form, for example from liquid or solid to gas. This rapid reaction creates a force that is capable of separating the graphite layers, and may result in a significant increase in volume. This expansion is sometimes referred to as exfoliation. In one or more embodiments, the expansion volume and the onset temperature may be controlled by selecting the intercallant and adjusting parameters within the intercalation process.

Examples of intercallant materials include halogens, alkali metals, sulfates, nitrates, various organic acids, aluminum chlorides, ferric chlorides, other metal halides, arsenic sulfides, and thallium sulfides. In certain embodiments of the present invention, the expandable graphite includes non-halogenated intercallant materials. In certain embodiments, the expandable graphite includes sulfate intercallants, also referred to as graphite bisulfate. As is known in the art, bisulfate intercalation is achieved by treating highly crystalline natural flake graphite with a mixture of sulfuric acid and other oxidizing agents which act to catalyze the sulfate intercalation.

Commercially available examples of expandable graphite include HPMS Expandable Graphite (HP Materials Solutions, Inc., Woodland Hills, Calif.) and Expandable Graphite Grades 1721 (Asbury Carbons, Asbury, N.J.). Other commercial grades contemplated as useful in the present invention include 1722, 3393, 3577, 3626, and 1722HT (Asbury Carbons, Asbury, N.J.).

In one or more embodiments, the expandable graphite may be characterized as having a mean or average size in the range from about 30 μm to about 1.5 mm, in other embodiments from about 50 μm to about 1.0 mm, and in other embodiments from about 180 μm to about 850 μm. In certain embodiments, the expandable graphite may be characterized as having a mean or average size of at least 30 μm, in other embodiments at least 44 μm, in other embodiments at least 180 μm, and in other embodiments at least 300 μm. In one or more embodiments, expandable graphite may be characterized as having a mean or average size of at most 1.5 mm, in other embodiments at most 1.0 mm, in other embodiments at most 850 μm, in other embodiments at most 600 μm, in yet other embodiments at most 500 μm, and in still other embodiments at most 400 μm. Useful expandable graphite includes Graphite Grade #1721 (Asbury Carbons), which has a nominal size of greater than 300 μm.

In one or more embodiments, the expandable graphite may be characterized as having a median size in the range from about 30 μm to about 1.5 mm, in other embodiments from about 50 μm to about 1.0 mm, and in other embodiments from about 180 μm to about 850 μm. In certain embodiments, the expandable graphite may be characterized as having a median size of at least 30 μm, in other embodiments at least 44 μm, in other embodiments at least 180 μm, and in other embodiments at least 300 μm. In one or more embodiments, expandable graphite may be characterized as having a median size of at most 1.5 mm, in other embodiments at most 1.0 mm, in other embodiments at most 850 μm, in other embodiments at most 600 μm, in yet other embodiments at most 500 μm, and in still other embodiments at most 400 μm. Useful expandable graphite includes Graphite Grade #1721 (Asbury Carbons), which has a nominal size of greater than 300 μm.

In one or more embodiments of the present invention, the expandable graphite may be characterized as having a nominal particle size of 20×50 (US sieve). US sieve 20 has an opening equivalent to 0.841 mm and US sieve 50 has an opening equivalent to 0.297 mm. Therefore, a nominal particle size of 20×50 indicates the graphite particles are at least 0.297 mm and at most 0.841 mm.

In one or more embodiments, the expandable graphite may be characterized as having a carbon content in the range from about 70% to about 99%. In certain embodiments, the expandable graphite may be characterized as having a carbon content of at least 80%, in other embodiments at least 85%, in other embodiments at least 90%, in yet other embodiments at least 95%, in other embodiments at least 98%, and in still other embodiments at least 99% carbon.

In one or more embodiments, the expandable graphite may be characterized as having a sulfur content in the range from about 0% to about 8%, in other embodiments from about 2.6% to about 5.0%, and in other embodiments from about 3.0% to about 3.5%. In certain embodiments, the expandable graphite may be characterized as having a sulfur content of at least 0%, in other embodiments at least 2.6%, in other embodiments at least 2.9%, in other embodiments at least 3.2%, and in other embodiments 3.5%. In certain embodiments, the expandable graphite may be characterized as having a sulfur content of at most 8%, in other embodiments at most 5%, in other embodiments at most 3.5%.

The change in volume of the graphite may be expressed as a ratio, and is sometimes referred to as the expansion ratio. In one or more embodiments, the expansion ratio may be expressed as the final volume, in cubic centimeters (cc), of one gram (g) of exfoliated expandable graphite. In one or more embodiments, the expandable graphite may be characterized as having an expansion ratio (cc/g) in the range from about 10:1 to about 500:1, in other embodiments at least 20:1 to about 450:1, in other embodiments at least 30:1 to about 400:1, in other embodiments from about 50:1 to about 350:1.

In certain embodiments, the expandable graphite may be characterized as having an expansion ratio (cc/g) of at least 10:1, in other embodiments at least 20:1, in other embodiments at least 30:1, in other embodiments at least 40:1, in other embodiments at least 50:1, in other embodiments at least 60:1, in other embodiments at least 90:1, in other embodiments at least 160:1, in other embodiments at least 210:1, in other embodiments at least 220:1, in other embodiments at least 230:1, in other embodiments at least 270:1, in other embodiments at least 290:1, and in yet other embodiments at least 300:1.

In certain embodiments, the expandable graphite may be characterized as having an expansion ratio (cc/g) of at most 350:1, and in yet other embodiments at most 300:1.

In one or more embodiments, the expandable graphite, as it exists within the pouch or binder component of the indicator of the present invention, is partially expanded. In one or more embodiments, the expandable graphite is not expanded, however, to a deleterious degree, which includes that amount or more of expansion that will deleteriously affect the ability to form the indicator product and the ability of the graphite to exhibit a visual change upon exposure to a critical temperature. In one or more embodiments, the expandable graphite is expanded to at most 100%, in other embodiments at most 50%, in other embodiments at most 40%, in other embodiments at most 30%, in other embodiments at most 20%, and in other embodiments at most 10% beyond its original unexpanded size.

In one or more embodiments, the expandable graphite may be characterized as having a pH in the range from about 1 to about 10; in other embodiments from about 1 to about 6; and in yet other embodiments from about 5 to about 10. In certain embodiments, the expandable graphite may be characterized as having a pH in the range from about 4 to about 7. In one or more embodiments, the expandable graphite may be characterized as having a pH of at least 1, in other embodiments at least 4, and in other embodiments at least 5. In certain embodiments, the expandable graphite may be characterized as having a pH of at most 10, in other embodiments at most 7, and in other embodiments at most 6.

Onset temperature, i.e. the temperature at which exfoliation of the graphite begins, may also be interchangeably referred to as expansion temperature. In one or more embodiments, the expandable graphite may be characterized by an onset temperature, ranging from about 100° C. to about 280° C.; in other embodiments from about 150° C. to about 260° C.; in other embodiments from about 170° C. to about 250° C.; in other embodiments from about 160° C. to about 225° C.; and in other embodiments from about 180° C. to about 200° C.

In one or more embodiments, the expandable graphite may be characterized by an onset temperature of at least 100° C., in other embodiments at least 130° C., in other embodiments at least 150° C., in other embodiments at least 160° C., in other embodiments at least 170° C., and in other embodiments at least 180° C. In one or more embodiments, the expandable graphite may be characterized by an onset temperature of at most 280° C., in other embodiments at most 260° C., in other embodiments at most 250° C., in other embodiments at most 225° C., and in other embodiments at most 200° C.

Binder

The binder portion of the indicator devices according to the present invention provides a matrix in which the expandable graphite is dispersed. The shape or form of the binder is not particularly limited, but may vary based upon the shape or form of the indicator device. For example, where the indicator device is a coating, the binder may be formed from a liquid coating that is dried or cured onto a tire surface. In one or more embodiments, the binder may be an adhesive resin, for example where the indicator device is a resin strip. In other embodiments, the binder may be formed from a liquid, gel, or semisolid material that cures/dries to form a strip or pouch.

For optimal effectiveness, the binder should readily allow for expansion of the graphite.

In certain embodiments, the indicator is a unitary, one-layer device. In these or other embodiments, the binder should be capable of adhesion to a tire surface, and impervious to weather and abrasion.

Liquid Coating/Binder

The binder is not particularly limited, as long as it readily allows for expansion of the graphite. In one or more embodiments, the binder is formed from a liquid coating composition. The term liquid refers to the compositions being in the liquid state at conditions of temperature and pressure that would be experienced during practical application of the compositions to a tire surface. In one or more embodiments, the compositions are liquids at temperatures from about −5° C. to about 110° C., in other embodiments from about 0° C. to about 100° C., and in other embodiments from about 10° C. to about 90° C.

In one or more embodiments, the expandable graphite may be dispersed within the constituents of the liquid coating and applied to a tire surface to form a wet coating mixture. Upon drying and/or curing the wet coating mixture, the indicator is formed. The dried or cured coating comprises the binder, and the expandable graphite is dispersed therein. Thus, the binder may be a dried or cured coating. While dried coatings and cured coatings may both be characterized as dimensionally stable, solid, protective films, they may be arrived at by different mechanisms. Dried coating refers to a coating that is formed by operation of evaporation. Cured coating is a coating that is formed via a chemical reaction, for example crosslinking.

In one or more embodiments, the binder is a polymeric (e.g. elastomeric) membrane. Useful polymeric compositions include polyurethane coating compositions, polymeric resin coating compositions, siloxane coating compositions, and combinations thereof. Epoxy compositions may be employed, if the epoxy readily allows for expansion of the graphite. In one or more embodiments, the coating compositions may be employed to prepare at least one layer of a monolithic (i.e. seamless), fully-adhered polymeric (e.g. elastomeric) membrane on a tire surface.

Polyurethane Coating

In one or more embodiments, the liquid coating composition is a polyurethane coating composition. These coatings are generally known as disclosed in U.S. Pat. Nos. 4,038,239 and 7,401,843, and U.S. Publ. No. 2012/0160414, all of which are incorporated herein by reference.

In one or more embodiments, the coating composition is a non-reactive polyurethane coating composition, which refers to the fact that the solids polymer portion of the coating composition does not include free or reactive isocyanate functionality. In other embodiments, the coating composition is a reactive polyurethane coating composition, which refers to the fact that the solids polymer portion of the coating composition includes free or reactive isocyanate functionality.

In one or more embodiments, the polyurethane coating composition includes a polyurethane latex or dispersion. As the skilled person understands, these compositions include polyurethane polymer dispersed within an aqueous medium. Upon application of the coating composition, the water evaporates and the remaining components form a dry polyurethane coating. Examples of polyurethane coating compositions, which may also be referred to as water-based polyurethane coating compositions, are described, for example, in U.S. Pat. No. 6,214,450, which is incorporated by herein by reference.

In other embodiments, the polyurethane coating composition is a solvent-borne composition. As the skilled person understands, these compositions include polyurethane polymer dispersed or dissolved within a solvent. Upon application of the liquid coating composition, the solvent evaporates and the remaining components form a dry polyurethane coating.

In other embodiments, reactive coating compositions are employed. These compositions may include one-part or two-part polyurethane compositions. In one or more embodiments, the composition is a one-part composition that may, for example, include one or more isocyanates or polyisocyanates (e.g. polyisocyanate prepolymers); these systems may be moisture curable. In other embodiments, the composition is a two-part composition wherein a first part supplies the isocyanates or polyisocyanates, and the second part supplies the hydroxyl-bearing compound such as a polyol.

In particular embodiments, the first part includes a urethane prepolymer that is formed from a polyol and an aliphatic isocyanate, optionally in the presence of a diluent. Any suitable polyol and aliphatic isocyanate may be used. For example, the polyol can be a caprolactonepolyol, a polyester polyol, a polyether polyol, or an acrylic polyol. The aliphatic isocyanate may be, but is not limited to, dicyclohexylmethanediisocyanate, trimethylhexamethylenediisocyanate, hexane diisocyanate, m-tetramethylxylenediisocyanate, 1,4-tetramethylene diisocyanate, and isophoronediisocyanate. Useful diluents that may be used include those compounds that can reduce the viscosity of the composition. Examples of suitable diluents include, but are not limited to, propylene carbonate, ethylene carbonate, butylene carbonate, odorless mineral spirits, plasticizers, and combinations thereof.

In one or more embodiments, the second part of the composition may include one or more aromatic or aliphatic amine crosslinkers. Examples of suitable amines include, but are not limited to, isophoronediamine, hindered aliphatic diamines, hexamethylenediamine, a polyoxypropylenediamine, 2-methylpentane diamine, 3-propane diamine, 2-methyl-1,5-pentane diamine, p-amino cyclohexyl methane, diethyl toluene diamine, di-(methylthio)toluene diamine, N,N′-dimethylaminodiphenylmethane, N,N′-diethylaminodiphenylmethane, and toluene diamine.

Additionally, the first or second part of the composition can include a plasticizer, pigment dispersions, dispersing aids, freeze/thaw stabilizers, and the like. Examples of suitable plasticizers include, but are not limited to, butyl benzyl phthalate, tricresylphosphate, triphenyl phosphate, butyl decyl phthalate, 1-Isopropyl-2,2dimethyltrimethylenediisobutyrate, dioctyl phthalate, triisooctyltrimellitate, diooctyladipate, and any other suitable phthalate and non-phthalate plasticizers. Examples of suitable dispersing aids include, but are not limited to Nuosperse 657 (Condea Servo LLC Piscataway, N.J.), BYK-104S (BYK-Chemie USA Wallingford, Conn.), and Disperbyk 190 (BYK-Chemie USA Wallingford, Conn.). Examples of suitable freeze/thaw additives include, but are not limited to, ethylene glycol, propylene glycol, glycerin, dipropylene glycol, and ethoxylatednonyl phenol. Examples of suitable pigment dispersions include, but are not limited to, titanium oxide and iron oxide pigments dispersed in plasticizer.

The first and second parts of the composition may be mixed to form the liquid coating. The liquid coating can be fast curing under normal temperature and humidity conditions. The first and second parts of the composition may be mixed in any suitable ratio. For example, the first and second parts of the composition may be mixed in a ratio between about 1:1 to a ratio of about 20:1 or a ratio of 2:1 or 5:1. The composition may be formulated so that the coating has a light color, such as white or off-white. The composition may have any suitable viscosity. For example, the first part may have a viscosity of between about 500 cps to about 1000 cps, and the second part may have a viscosity of between about 100 cps to about 300 cps. The composition may have an initial mixed viscosity of between about 2,000 cps to about 4,000 cps.

Resin Coatings

In one or more embodiments, the liquid coating composition is a polymeric resin coating composition. These coating compositions may also be referred to binder compositions or film-forming compositions. In one or more embodiments, these coating compositions include acrylic resins, vinyl acetate resins, halogen addition resins, and/or vinyl acrylic resins. Specific examples include Suncryl CP-50 vinyl acrylic resin. The term acrylic resin is used in its broadest sense and includes polymers and copolymers prepared from polymerizing monomer including acrylic acid, methacrylic acid, acrylates, methacrylates, acrylamides, methacrylimides, and/or acrylonitrile. In one or more embodiments, the resin coating compositions are non-reactive compositions. In other embodiments, the resin coating compositions are reactive compositions. In one or more embodiments, the reactive resin compositions may include one-part or two-part reactive resin compositions. In one or more embodiments, these coating compositions are in the form of a latex. Exemplary resin coatings are generally known as disclosed in U.S. Pat. Nos. 4,229,329, 4,859,723, 4,745,032, and 6,174,960, all of which are incorporated herein by reference.

In one or more embodiments, the polymeric resin composition includes polymer characterized by a number average molecular weight that is greater than 10 kg/mol, in other embodiments greater than 25 kg/mol, and in other embodiments greater than 50 kg/mol. In these or other embodiments, the polymer may be characterized by a number average molecular weight of from about 10 kg/mol to about 500 kg/mol, in other embodiments from about 25 kg/mol to about 300 kg/mol, and in other embodiments from about 50 kg/mol to about 200 kg/mol.

In one or more embodiments, the polymeric resin composition is a latex that may be characterized by a solids content of at least 40 wt %, in other embodiments at least 50 wt %, and in other embodiments at least 60 wt %. In these or other embodiments, the composition is a latex that may be characterized by a solids content of at most 90 wt %, in other embodiments at most 80% wt %, and in other embodiments at most 70 wt %. In these or other embodiments, the latex may be characterized by a solids content of from about 40 wt % to about 90 wt %, in other embodiments from about 50 wt % to about 80 wt %, and in other embodiments from about 60 wt % about 70 wt %.

In one or more embodiments, the polymeric resin composition includes polymer that, upon film formation, may be characterized by a Tg of less than 40° C., in other embodiments less than 20° C., in other embodiments less than 0° C., in other embodiments less than −20° C., and in other embodiments less than −40° C. In these or other embodiments, the polymer may be characterized by a Tg of from about −60° C. to about 40° C., in other embodiments from about −40° C. to about 20° C., and in other embodiments from about −20° C. about 0° C.

In one or more embodiments, the polymeric resin composition is a latex that may be characterized by a pH of at least 4, in other embodiments at least 5, and in other embodiments at least 7. In these or other embodiments, the composition is a latex that may be characterized by a pH of at most 9, in other embodiments at most 8, and in other embodiments at most 7. In these or other embodiments, the latex may be characterized by a pH of from about 4 to about 9, in other embodiments from about 5 to about 8, and in other embodiments from about 7 about 8.

In one or more embodiments, the resin polymer includes one or more units deriving from a monomer selected from vinylidene fluoride, vinyl fluoride, trifluoroethylene, chlorotrifluoroethylene (CTFE), tetrafluoroethylene (TFE), and hexafluoropropylene (HFP) and their respected copolymers. Examples of these coating compositions are disclosed in U.S. Pat. No. 7,803,867, which is incorporated by reference.

In one or more embodiments, the resin polymer includes one or more units deriving from a monomer selected from alyloxy propane diol (AOPD), isobutylmethacrylate, acetoacetoxyethylmethacrylate (AEA or AAEM), N-alkyl methacrylamide, N-methylolmethacrylamide or NMA, N-alkyl acrylamide, N-dialkyl methacrylamide, N-dialkyl acrylamide, isobutoxymethacrylamide (IBMA or iBMA)), ethylenically unsaturated monomers containing hydroxyl groups (hydroxylethyl methacrylate or HEMA, hydroxyethyl acrylate, hydroxypropyl acrylate, hydroxypropyl methacrylate, diethylene glycol ethyl acrylate or DGEA for example), monomers containing epoxy groups (glycidyl acrylate, glycidyl methacrylate or GMA, for example), monomers containing silanols (trimethoxysilane methacrylate, triethoxysilane methacrylate, trimethyl silyl propyl acrylate (TMPA or TMSPA), for example), and monomers containing aldehyde functions, such as acrolein, alkenyl cyanides, such as acrylonitrile methacrylonitrile.

In one or more embodiments, the resin polymer includes one or more units deriving from a monomer selected from conjugated dienes, for example, 1,3-butadiene, isoprene, fluoro alkyl acrylates, fluoro alkyl methacrylates, aromatic alkenyl compounds, for example, styrene, alpha-methylstyrene, styrene halides and divinyl hydrocarbon compounds, for example, divinyl benzene.

Polysiloxanes

In one or more embodiments, the liquid coating composition includes one or more polysiloxane polymers. These polymers may be referred to as silicone coating compositions, or simply as silicones. Examples of silicones include 100% silicone sealant, available from Henkel Corporation under the tradename Loctite, and 100% silicone caulk, available from General Electric.

In one or more embodiments, these polymers include one or more functional groups that facilitate or activate crosslinking of the polymers. Examples of these coating compositions are disclosed in U.S. Pat. No. 4,668,315, which is incorporated herein by reference.

In one or more embodiments, the siloxane coating compositions of this embodiment include polysiloxane polymers dispersed or dissolved in a solvent. In one or more embodiments, these compositions may be characterized by a solids content of at least 40 wt %, in other embodiments at least 50 wt %, and in other embodiments at least 60 wt %. In these or other embodiments, these compositions may be characterized by a solids content of at most 95 wt %, in other embodiments at most 85% wt %, and in other embodiments at most 75 wt %. In these or other embodiments, these compositions may be characterized by a solids content of from about 50 wt % to about 95 wt %, in other embodiments from about 65 wt % to about 90 wt %, and in other embodiments from about 80 wt % about 85 wt %.

In one or more embodiments, the siloxane coating composition includes a polysiloxane polymer characterized by a number average molecular weight that is greater than 10 kg/mol, in other embodiments greater than 25 kg/mol, and in other embodiments greater than 50 kg/mol. In these or other embodiments, the polysiloxane polymer may be characterized by a number average molecular weight of from about 10 kg/mol to about 500 kg/mol, in other embodiments from about 25 kg/mol to about 300 kg/mol, and in other embodiments from about 50 kg/mol to about 200 kg/mol.

### Specific Examples

In one or more embodiments, the binder is selected from silicone, HV chemical cement, available from Patch Rubber Company, self-vulcanizing, fast dry cement, available from Patch Rubber Company, and flexible adhesive, including Loctite fabric, vinyl, and plastic adhesive available from Henkel Corporation.

Additional Constituents of Liquid Coating

In one or more embodiments, the liquid coating composition may include one or more plasticizers, pigment dispersions, dispersing aids, freeze/thaw stabilizers, catalyst compounds, fillers, and/or other ingredients that are generally known in the art.

Pouch

In one or more embodiments, the indicator includes a pouch that encases a plurality of expandable graphite particles. The particles may or may not be dispersed in a binder. The indicator may include expandable graphite particles dispersed or encapsulated within a pouch that may be adhered to a surface of a tire. Exposure of the tire to excessive temperature causes the graphite to expand within the pouch, producing a noticeable change in the volume and/or shape of the pouch. In one or more embodiments, expansion of the graphite causes the pouch to burst.

Examples of suitable materials for forming the pouch include tire patch materials that are known in the art. In one or more embodiments, the pouch comprises gum rubber. Tire patch materials are further described in U.S. Pat. Nos. 4,285,382, 4,434,832, 6,386,255, and 9,321,223, all of which are incorporated by reference herein.

Characteristics of Pouch or Binder

Advantageously, the pouch or binder provides a holder or matrix for the expandable graphite that allows for expansion of the graphite, while resisting abrasion and exposure to the environment in which the tire operates. In one or more embodiments, the pouch or binder may be characterized by a relatively low modulus. In some embodiments, the 100% modulus of the binder is less than about 10 megapascal (MPa), in other embodiments, less than about 5 MPa, in other embodiments, less than about 2 MPa, in other embodiments, less than about 1 MPa, in other embodiments, less than about 0.1 MPa, as measured according to ASTM D 412.

Preparation of Indicator

In one or more embodiments, for example where the indicator is a pouch or a resin strip, the indicator may be prepared, and then subsequently applied to a tire. The indicator may be applied to the tire either before or after the tire is cured. In one or more embodiments, the pouch or binder may be dried or cured after the indicator has been positioned on the tire.

In other embodiments, a pouch may be formed by adhering the edges of a sheet to a surface of a tire, leaving a cavity within to hold the expandable graphite. In these embodiments, the tire surface forms one side of the pouch.

In one or more embodiments, the indicator may be prepared by dispersing the expandable graphite into the binder. In one or more embodiments, the indicator may be prepared by dispersing the expandable graphite into a liquid coating composition to form a liquid coating dispersion, and then drying or curing the liquid coating dispersion to form a binder having the expandable graphite dispersed therein. The dried or cured indicator may then be applied to a tire, either before or after the tire is cured. In other embodiments, the liquid coating dispersion may be applied to a tire, and then dried or cured. The liquid coating dispersion may be applied to the tire either before or after the tire is cured.

Where liquid coating compositions are employed, the incorporation of the expandable graphite into these compositions need not alter conventional practices for preparing the compositions. Where the coating composition is a one-part composition, such as an acrylic coating composition or a moisture-curable coating composition, the expandable graphite may be added to the composition before, after, or during incorporation of the other constituents of the composition. Where the coating composition is a two-part composition, such as a two-part polyurethane composition, the expandable graphite may be added to either the first component (e.g. the A side), the second component (e.g. the B side), or both the first and second components.

In one or more embodiments, the liquid coating compositions may be prepared by employing a two-stage mixing process. For example, all of the constituents of the liquid coating composition, except for the expandable graphite, may be first mixed. By mixing the constituents excluding the expandable graphite in a first mixing step, the temperature and/or degree of mixing can be increased as necessary to achieve greater dispersion and/or mixing of the constituents without triggering expansion of or otherwise impact the expandable graphite. Once these constituents are mixed at an appropriate temperature (which will form a premixture), the composition can be cooled, if necessary, and the expandable graphite can then be introduced to the premixture and further mixing may take place to disperse the expandable graphite within the liquid coating composition at an appropriate temperature.

Amount of Graphite

The amount of expandable graphite is not limited. In one or more embodiments, the minimum amount of expandable graphite is an amount that is sufficient to be visually observable.

In one or more embodiments, the liquid coating dispersion includes at least 0.5 wt. %, in other embodiments at least 1.0 wt. %, in other embodiments at least 3 wt. %, in other embodiments at least 5 wt. %, and in other embodiments at least 7 wt. %, in other embodiments at least 10 wt. %, in other embodiments at least 15 wt. % expandable graphite, based on the entire weight of the liquid coating dispersion.

In these or other embodiments, the liquid coating dispersion includes at most 50 wt. %, in other embodiments at most 30 wt. %, in other embodiments at most 25 wt. %, and in other embodiments at most 22 wt. % expandable graphite, based on the entire weight of the liquid coating dispersion.

In one or more embodiments, the liquid coating dispersion includes from about 0.5 wt. % to about 40 wt. %, and in other embodiments from about 1 wt. % to about 25 wt. % expandable graphite, based upon the entire weight of the liquid coating dispersion.

In one or more embodiments, the indicator includes at least 1 wt. %, in other embodiments at least 3 wt. %, in other embodiments at least 5 wt. %, in other embodiments at least 7 wt. %, and in other embodiments at least 10 wt. % expandable graphite, based on the combined weight of the graphite and binder.

In these or other embodiments, the indicator includes at most 50 wt. %, in other embodiments at most 40 wt. %, in other embodiments at most 30 wt. %, and in other embodiments at most 25 wt. % expandable graphite, based on the combined weight of the graphite and binder.

In one or more embodiments, the indicator includes from about 1 wt. % to about 50 wt. %, in other embodiments from about 2 wt. % to about 40 wt. %, and in other embodiments from about 3 wt. % to about 30 wt. % expandable graphite, based upon the combined weight of the graphite and binder.

Tire

In one or more embodiments, the indicator device is employed on a tire, and provides a visual indication that a tire has been exposed to excessive temperature.

Preparation of Tire

The type of tire and the method of preparing the tire are not particularly limited. Tire components may be prepared according to ordinary tire manufacturing techniques including standard rubber shaping, molding and curing techniques. Typically, vulcanization is effected by heating the vulcanizable composition in a mold; e.g., it may be heated to about 140° C. to about 180° C. Cured or crosslinked rubber compositions may be referred to as vulcanizates, which generally contain three-dimensional polymeric networks that are thermoset. The other ingredients, such as fillers and processing aids, may be evenly dispersed throughout the crosslinked network.

When the indicator is formed from a coating, the coating may be applied to the tire surface by conventional techniques of spraying, painting, and the like. The coating may then be dried or cured. In certain embodiments, the coating may be dried or cured, and then adhered to the tire surface.

Types of Tires

In one or more embodiments, the indicator may be employed in off-road tires, i.e. tires that have a primary use or working surface condition that is not on a paved road. Examples of off-road tires include those used on earthmovers, industrial and mining equipment, agricultural tires, lawn and garden tires, all terrain vehicles (ATVs) and dirt bikes or motocross motorcycles.

Industrial/agricultural tires are further described in U.S. Patent Publication No. 2005/0139302 A1, U.S. Pat. Nos. 3,844,326, 4,202,391, 4,611,647, 4,791,971, 4,649,976, 5,046,541, 5,063,573, 5,188,683, 5,337,814, 5,337,816, 5,421,388, 5,464,050, 5,901,765, 6,179,027, 6,260,594, 6,263,933, 6,450,221, 6,481,479, and 8,136,562. each of which is incorporated herein by reference.

In one or more embodiments, the indicator of the present invention is employed in tires for all terrain or rough terrain vehicles. All terrain tires are further described in U.S. Pat. Nos. 4,881,586, 5,259,429, 5,318,086, 5,375,640, 6,293,323, 6,298,890, 6,401,774, 6,799,617, and 6,929,044, and 8,136,562, each of which is incorporated herein by reference.

In one or more embodiments, the indicator of the present invention is employed in pneumatic tires. Pneumatic tires can be made as discussed in U.S. Pat. Nos. 5,866,171, 5,876,527, 5,931,211, and 5,971,046, each of which is incorporated herein by reference.

In one or more embodiments, the indicator of the present invention is employed in commercial tires, for example tires for trucks, buses, and commercial vans. Commercial tires are further described in U.S. Patent Application Publication Nos. 2003/0089441 A1, 2016/0377507 A1, and 2015/0361252 A1, each of which is incorporated herein by reference.

In one or more embodiments, the indicator of the present invention is employed in aircraft tires. Aircraft tires are further described in U.S. Patent Application Publication Nos. 2016/0075181 A1, 2016/0075188 A1, 2016/0167444 A1, 2016/0059639A1, as well as U.S. Pat. Nos. 7,950,430, 7,216,684, and 8,371,352, each of which is incorporated herein by reference.

Placement of Indicator on Tire

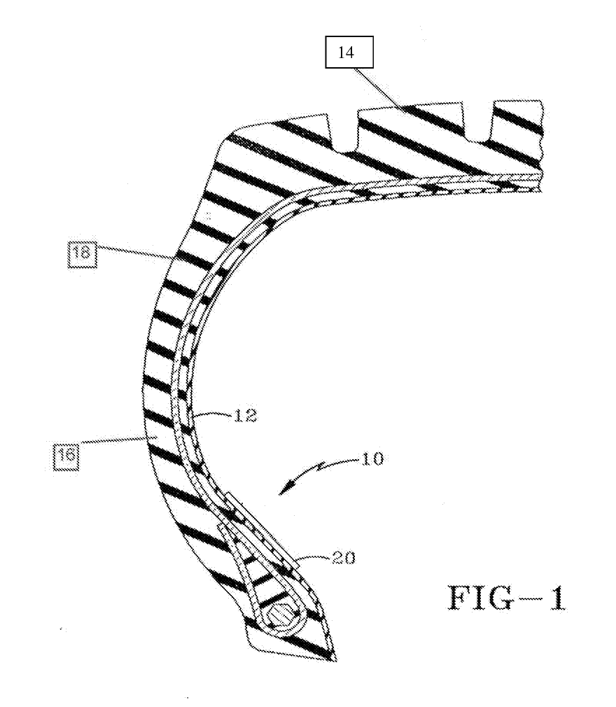

A sectional view of a typical tire is shown in FIG. 1. Tire 10 includes an inner surface 12, tread portion 14, sidewalls 16, and shoulders 18. Indicator 20 is shown located on shoulder 18. It will be appreciated that indicator 20 may be located in a variety of locations on the tire, including on an inner surface or an outer surface, tread portion, sidewall, or shoulder. In one or more embodiments, indicator 20 may be located on the lower sidewall. In one or more embodiments, indicator 20 may be located on an inner or outer surface near the rim.

Operation of Indicator on Tire

As described above, expandable graphite is characterized by the property that it expands/exfoliates under certain conditions. This expansion may be visually apparent, due to a change in the appearance, shape, volume or texture of the graphite, which may also lead to a change in the appearance, shape, volume or texture of the indicator. For example, the so-called “popcorn” effect may result. The popcorn effect of expandable graphite is further described in U.S. Pat. No. 5,968,669, which is hereby incorporated by reference.

In one or more embodiments, the indicator may initially be characterized by a certain, uniform appearance, shape, volume, and a relatively smooth surface. Under conditions of standard temperature and pressure, and/or under the normal operating conditions of a tire, the appearance, shape, volume, and texture of the indicator does not substantially change.

Upon exposure of the indicator to a temperature that meets or exceeds the onset temperature of the expandable graphite, the appearance, shape, volume, and/or texture of the indicator surface is visually different, primarily due to the change in the appearance, shape, volume, and/or texture of the expandable graphite.

In one or more embodiments, the expandable graphite may be dispersed or encapsulated within a pouch. Exposure to excessive temperature causes the graphite to expand within the pouch, producing a noticeable change in the volume and/or shape of the pouch. In one or more embodiments, expansion of the graphite causes the pouch to burst.

Advantageously, by selection of the pouch or binder, the expandable graphite, placement of the indicator on the tire, and other factors, the indicator may be configured to indicate a pre-selected temperature. Thus, the present invention provides a method for detecting that a tire has been exposed to a pre-selected temperature. The method includes the step of providing a tire that includes at least one indicator device, the indicator device comprising a binder and expandable graphite dispersed in the binder, and the indicator having an initial appearance, shape, volume and texture. The method includes the further step of visually inspecting the tire to detect a change in the appearance, shape, volume or texture of the indicator device. A change in any of these attributes indicates that the tire has been exposed to a temperature that meets or exceeds the pre-selected temperature.

In one or more embodiments, the pre-selected temperature may be one that has been determined to lead to damage or excessive wear to the tire. In these or other embodiments, the pre-selected temperature may be referred to as a critical temperature.

Critical Temperature for Tires

In one or more embodiments, the critical temperature, e.g. the temperature at which the change in indicator commences, is about 130° C., in other embodiments, about 140° C., in other embodiments, about 150° C., in other embodiments, about 160° C., in other embodiments, about 170° C., in other embodiments, about 180° C.

Advantageously, according to methods of the present invention, a tire may be inspected visually, without removing the tire from the rim, and without resort to mechanical or chemical testing. Methods of the present invention provide a method whereby a tire's exposure to temperatures that can lead to internal damage, which normally would not be visually apparent, can be visually detected. If the visual inspection reveals that there has been a change in the indicator, the tire may be suspected of having been exposed to excessive temperature, and may be replaced, or flagged for further testing. Embodiments of the invention provide a method for predicting that a tire has been exposed to excessive temperature and should not be retreaded.

Various modifications and alterations that do not depart from the scope and spirit of this invention will become apparent to those skilled in the art. This invention is not to be duly limited to the illustrative embodiments set forth herein.

1. A tire having an indicator device that indicates exposure of the tire to a pre-selected temperature, the indicator device comprising expandable graphite dispersed within a pouch or binder.

2. The tire of claim 1, where the indicator is in the form of a coating, a resin strip, or pouch.

3. The tire of claim 1, where the indicator is located on a surface of the tire.

4. The tire of claim 1, where the indicator is multi-layered, wherein at least one layer includes expandable graphite and a binder and wherein the binder is formed from a liquid coating that is dried or cured.

5. (canceled)

6. The tire of claim 4, where the binder is a polymeric membrane.

7. An indicator device that may be positioned on a tire, for indicating that the tire has been exposed to a pre-selected temperature, the device comprising expandable graphite and a pouch or binder.

8. The indicator device of claim 7, where the pre-selected temperature is at least 130° C.

9. The indicator device of claim 7, where the indicator is in the form of a coating, a resin strip, or pouch.

10. The indicator device of claim 7, where the indicator is located on a surface of the tire.

11. The indicator device of claim 7, where the indicator is multi-layered, wherein at least one layer includes expandable graphite and a binder and where the binder is formed from a liquid coating that is dried or cured.

12. (canceled)

13. The indicator device of claim 11, where the binder is a polymeric membrane.

14. The indicator device of claim 11, where the binder is formed from a coating composition that is selected from the group consisting of polyurethane coating compositions, polymeric resin coating compositions, siloxane coating compositions, and combinations thereof.

15. A method for detecting that a tire has been exposed to a pre-selected temperature, the method including the steps of:
providing a tire that includes at least one indicator device, the indicator device comprising a pouch or binder and expandable graphite dispersed in the pouch or binder, and the indicator having an initial appearance, shape, volume and texture;
visually inspecting the tire to detect a change in the appearance, shape, volume or texture of the indicator device, wherein a change in appearance, shape, volume or texture indicates that the tire has been exposed to a temperature that meets or exceeds the pre-selected temperature.

16. The method of claim 15, where the pre-selected temperature is at least 130° C.

17. The method of claim 15, where the indicator is in the form of a coating, a resin strip, or pouch.

18. The method of claim 15, where the indicator is located on a surface of the tire.

19. The method of claim 15, where the indicator is multi-layered, wherein at least one layer includes expandable graphite and a binder.

20. The method of claim 19, where the binder is formed from a liquid coating that is dried or cured.

21. The method of claim 19, where the binder is a polymeric membrane.

22. The method of claim 19, where the binder is formed from a coating composition that is selected from the group consisting of polyurethane coating compositions, polymeric resin coating compositions, siloxane coating compositions, and combinations thereof.
